(19) United States
(12) Patent Application Publication
(10) Pub. No.: US 2014/0209448 A1
(43) Pub. Date: Jul. 31, 2014

(54) STRIPPING SYSTEM

(71) Applicant: IHI Corporation, Koto-ku (JP)

(72) Inventors: Ryo NAKAZAWA, Tokyo (JP); Koichi Yuasa, Tokyo (JP)

(73) Assignee: IHI Corporation, Koto-ku (JP)

(21) Appl. No.: 14/108,831

(22) Filed: Dec. 17, 2013

(30) Foreign Application Priority Data
Jan. 28, 2013 (JP) 2013-013558

(51) Int. Cl. C02F 1/04

(52) U.S. Cl. CPC C02F 1/043
USPC 202/166

(57) ABSTRACT

A stripping system includes: a boiler which generates steam by heating water; a first heat exchanger (latent heat exchanger) which collects latent heat of the steam generated by the boiler, and thereby condenses the steam into condensed water; a second heat exchanger (sensible heat exchanger) which collects sensible heat of the condensed water, and thereby heats untreated water absorbing ammonia; and a stripping tower which receives the heated untreated water introduced therein, and vaporizes the ammonia from the heated untreated water.

### BACKGROUND OF THE INVENTION

1. Field of the Invention

The present invention relates to a stripping system configured to separate a target substance from untreated water by vaporizing the target substance dissolved in the untreated water.

2. Background Art

A stripping tower has been used in order to separate ammonia from untreated water in which the ammonia (ammonium nitrogen) is dissolved. The stripping tower removes the ammonia from the untreated water by vaporizing the ammonia. The ammonia vaporized in the stripping tower is guided to the outside from the top of the tower together with steam, while the treated water (drainage water) from which the ammonia is removed is discharged from the lower portion of the stripping tower. For enhancing vaporization efficiency of the ammonia, the stripping tower of this kind introduces not only the untreated water but also steam therein to heat the untreated water.

The configuration of introducing the steam inevitably entails a larger amount of energy to generate the steam, and accordingly pushes up energy costs. Furthermore, the amount of drainage water discharged from the stripping tower becomes larger according to amount of the added steam. This poses a problem of an increase in costs of treating the drainage water.

Against this background, Japanese Patent Application Laid-Open Publication No. 2002-28637 (Patent Document 1) has disclosed a technique for reducing an amount of steam introduced into a stripping tower by: preheating untreated water by use of heat of a gaseous mixture (stripped gas) of ammonia and steam guided from the top of the tower; and thereafter introducing the preheated untreated water into the stripping tower.

### SUMMARY OF THE INVENTION

However, 100% of the heat of the stripped gas cannot be transferred to the untreated water. Accordingly, when the untreated water is preheated by use of the above-described technique of Patent Document 1, the untreated water cannot be heated to an optimum temperature for vaporizing the ammonia. For this reason, even the technique of Patent Document 1 cannot drastically reduce the amount of energy needed to heat the untreated water.

With this problem taken into configuration, an object of the present invention is to provide a stripping system capable of drastically reducing an amount of energy needed to heat untreated water, and enhancing vaporization efficiency of a target substance in the untreated water.

An aspect of the present invention provides a stripping system which includes: a boiler configured to generate steam by heating water; a first heat exchanger configured to collect latent heat of the steam generated by the boiler, and thereby to condense the steam into condensed water; a second heat exchanger configured to collect sensible heat of the condensed water, and thereby to heat any of untreated water absorbing ammonia and untreated water absorbing an acid gas by use of the collected heat; and a stripping tower into which the heated untreated water is introduced, the stripping tower configured to vaporize any of the ammonia and the acid gas from the untreated water.

The stripping system may further include an air introducer configured to introduce heated air into the stripping tower.

Here, a heat source for the boiler may be a synthesis gas generated by heating a gasifiable material.

The stripping system may further include a washer configured to wash the synthesis gas with water, thereby to cause the water to absorb ammonia contained in the synthesis gas, and thus to obtain the untreated water containing the ammonia. Here, the second heat exchanger may collect the sensible heat of the condensed water, and heat the untreated water obtained by the washer by use of the collected heat. Moreover, the stripping tower may receive the heated untreated water introduced therein, and vaporize the ammonia from the untreated water.

The stripping system may further include an absorbing unit configured to wash the synthesis gas with an absorbing solution, thereby to cause the absorbing solution to absorb the acid gas contained in the synthesis gas, and thus to obtain the untreated water containing the acid gas. Here, the second heat exchanger may collect the sensible heat of the condensed water, and heat the untreated water obtained by the absorbing unit by use of the collected heat. Moreover, the stripping tower may receive the heated untreated water introduced therein, and vaporize the acid gas from the untreated water.

The present invention makes it possible to drastically reduce an amount of energy needed to heat untreated water, and to enhance vaporization efficiency of a target substance in the untreated water.

### BRIEF DESCRIPTION OF THE DRAWINGS

FIG. 1 is a diagram for explaining a synthesis gas generating system of a first embodiment of the present invention.

FIG. 2 is a diagram for explaining a relationship between a temperature of an ammonia-containing solution and an ammonia removal rate in a stripping tower.

FIG. 3 is a diagram for explaining a synthesis gas generating system of a second embodiment of the present invention.

### DETAILED DESCRIPTION OF THE PREFERRED EMBODIMENTS

Referring to the attached drawings, detailed descriptions will be hereinbelow provided for the preferred embodiments of the present invention. Dimensions, materials, specific values and the like shown in the embodiments are provided just as examples for facilitating understanding of the invention, and none of them limit the present invention unless otherwise specified. It should be noted that in the specification and drawings, components having substantially the same functions and configurations will be denoted by the same reference signs, and duplicate descriptions for such components will be omitted. In addition, illustration of components not directly related to the present invention will be omitted.

### First Embodiment

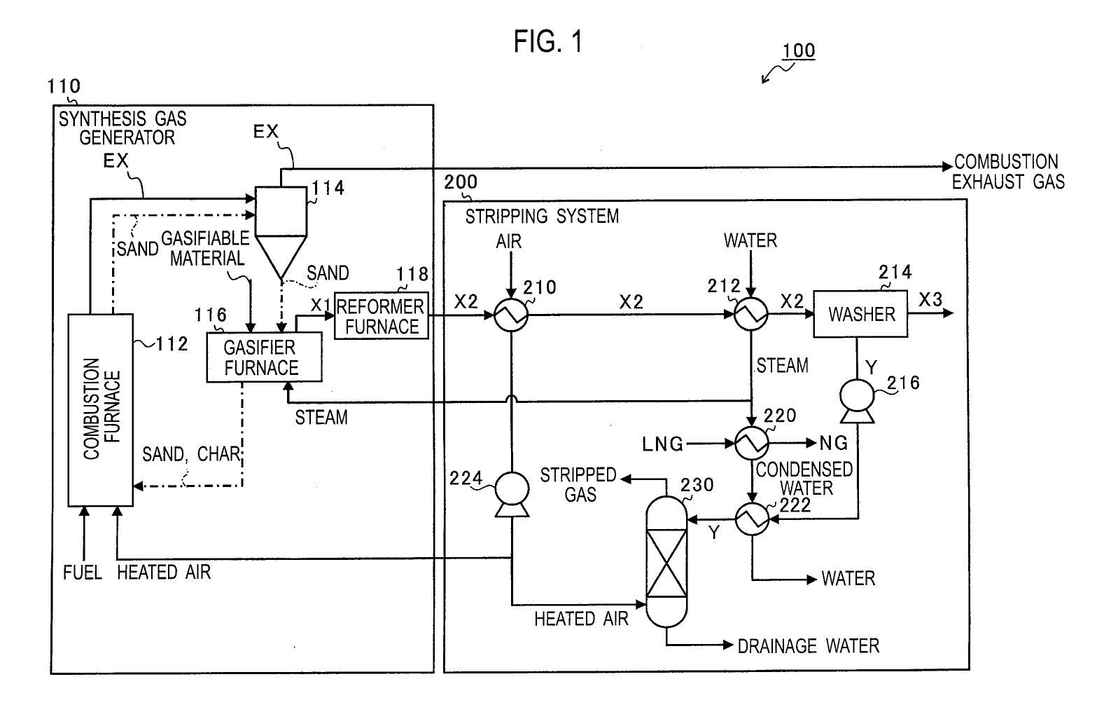

FIG. 1 is a diagram for explaining a synthesis gas generating system 100 of a first embodiment of the present invention. As shown in FIG. 1, the synthesis gas generating system 100 includes a synthesis gas generator 110 and a stripping system 200. In FIG. 1, flows of sand are indicated with chain dashed lines, while flows of things other than the sand including, a gasifiable material, gases, water, oil, and the like are indicated with solid lines.

The synthesis gas generating system 100 demonstrates a technology for generating a gasified gas by gasifying a solid material such as coal, biomass, and tire chips as substitute for petroleum. Examples of the coal include peat, lignite, brown coal, subbituminous coal, bituminous coal, semi-anthracite and anthracite. The following descriptions will be provided for specific configurations of the synthesis gas generator 110 and the stripping system 200 constituting the synthesis gas generating system 100 in this order.

### Synthesis Gas Generator 110

As shown in FIG. 1, the synthesis gas generator 110 includes a combustion furnace 112, a medium separator (cyclone) 114, a gasifier furnace 116 and a reformer furnace (oxidation reformer furnace) 118.

The synthesis gas generator 110 as a whole circulates a fluid medium, which is made from sand such as silica sand with a particle size of approximately 300 μm, as a heating medium. Specifically, the moving medium is first heated to approximately 1000° C. in the combustion furnace 112, and is subsequently introduced into the medium separator 114 together with a combustion exhaust gas EX containing carbon dioxide (CO₂). In the medium separator 114, the high-temperature moving medium and the combustion exhaust gas EX are separated from each other. Thereafter, the high-temperature moving medium thus separated is introduced into the gasifier furnace 116. The moving medium introduced into the gasifier furnace 116 is then turned into a fluidized bed by a gasifying agent (steam, nitrogen, air, oxygen, inert gases or the like) introduced into the gasifier furnace 116 through its bottom surface. Eventually, the fluidized bed is returned to the combustion furnace 112.

The gasifier furnace 116 is a bubbling fluidized bed gasifier furnace, for example. The gasifier furnace 116 generates a gasified gas by gasifying a gasifiable material, for example, low-grade fuel such as brown coal, at a temperature of 700° C. to 900° C. In this embodiment, the gasified gas is generated by gasifying the gasifiable material while supplying steam to the gasifier furnace 116 (steam gasification).

Here, descriptions will be provided by citing the gasifier furnace 116 that employs the circulating fluidized bed method as an example. However, a gasifier furnace employing a simple fluidized bed method, or a gasifier furnace employing a moving bed method in which sand is formed into a moving bed by being let to flow vertically downward due to its own weight may be used as the gasifier furnace 116, as long as such a gasifier furnace is appropriately designed for gasifying a gasifiable material.

The reformer furnace 118 reforms (by oxidation) tar contained in a synthesis gas X1 generated by the gasifier furnace 116 by adding oxygen and air to the synthesis gas X1,and heating the resultant mixture to approximately 900° C. to 1500° C. A synthesis gas X2 obtained through the reforming process by the reformer furnace 118 contains ammonia, tar and the like. For this reason, the synthesis gas X2 is sent to the stripping system 200 located downstream and is refined there.

### Stripping System 200

The stripping system 200 includes an air heater 210, a boiler 212, a washer 214, an untreated water sending unit 216, a latent heat exchanger (first heat exchanger) 220, a sensible heat exchanger (second heat exchanger) 222, an air introducer 224 and a stripping tower 230.

The air heater 210 exchanges heat between the synthesis gas X2 and the air, as well as thereby cools the synthesis gas X2 and heats the air.

The boiler 212 generates steam by heating water by use of the heat of the synthesis gas X2. To put it specifically, the boiler 212 exchanges heat between the synthesis gas X2 and the water, as well as thereby cools the synthesis gas X2 and generates the steam by heating the water. The temperature of the synthesis gas X2 at an outlet of the boiler 212 is in a range of 300° C. to 600° C., for example.

The washer 214 washes the synthesis gas X2 with water, and thus makes the water absorb the ammonia contained in the synthesis gas X2. Thereby, the washer 214 obtains an ammonia-containing solution (untreated water) Y in which the ammonia is absorbed (dissolved). The temperature of the ammonia-containing solution Y is approximately 70° C., for example. To put it specifically, the washer 21 is formed from a spray tower, and lowers the temperature of the synthesis gas X2 at 300° C. to 600° C. to approximately 50° C. by spaying the cooling water at a temperature of approximately 40° C. to the synthesis gas X2. Thereby, the ammonia contained in the synthesis gas X2 is absorbed into the water, and is thus removed from the synthesis gas X2. Eventually, a refined gas X3 and the ammonia-containing solution Y are generated. Thereafter, the refined gas X3 thus generated is supplied to a subsequent facility which uses the refined gas.

The untreated water sending unit 216 is formed from a pump, for example, and sends the ammonia-containing solution Y generated by the washer 214 to the stripping tower 230 via the sensible heat exchanger 222, which will be described later.

The latent heat exchanger 220 condenses the steam generated by the boiler 212 into condensed water by collecting the latent heat of the steam. In the embodiment, the latent heat exchanger 220 exchanges heat between the steam generated by the boiler 212 and LNG (liquefied natural gas), as well as thereby condenses the steam and turns the LNG into NG (natural gas) by heating the LNG. The NG thus generated is used as fuel for an auxiliary boiler, or as a combustion improver for a flare system (a facility for burning off unnecessary exhaust gas). In addition, the temperature of the condensed water generated by the latent heat exchanger 220 is approximately 100° C., for example.

The sensible heat exchanger 222 collects the sensible heat of the condensed water condensed by the latent heat exchanger 220, and heats the ammonia-containing solution Y by use of the heat thus collected. To put it specifically, the sensible heat exchanger 222 exchanges heat between the condensed water and the ammonia-containing solution Y, as well as thereby cools the condensed water and heats the ammonia-containing solution Y. The sensible heat exchanger 222 heats the ammonia-containing solution Y to approximately 80° C. to 90° C., for example.

The air introducer 224 is formed from a blower, for example, and introduces the air (heated air) heated by the air heater 210 into the combustion furnace 112 and the stripping tower 230. The configuration including the air heater 210 and the air introducer 224 makes it possible to raise the temperature of the air introduced into the combustion furnace 112, and to reduce a loss of thermal energy in the combustion furnace 112 which is caused by the air. This makes it possible to reduce the amount of fuel consumption in the combustion furnace 112.

Furthermore, the configuration including the air heater 210 and the air introducer 224 makes it possible to raise the temperature inside the stripping tower 230, which will be described later, and to enhance vaporization efficiency of the ammonia by the stripping tower 230.

The ammonia-containing solution Y heated by the sensible heat exchanger 222 and the heated air are introduced into the stripping 230, which generates a stripped gas (a gaseous mixture of ammonia, steam and air) and drainage water by vaporizing (removing) the ammonia from the ammonia-containing solution Y. Incidentally, the temperature of the stripped gas discharged from the stripping tower 230 is approximately 80° C.

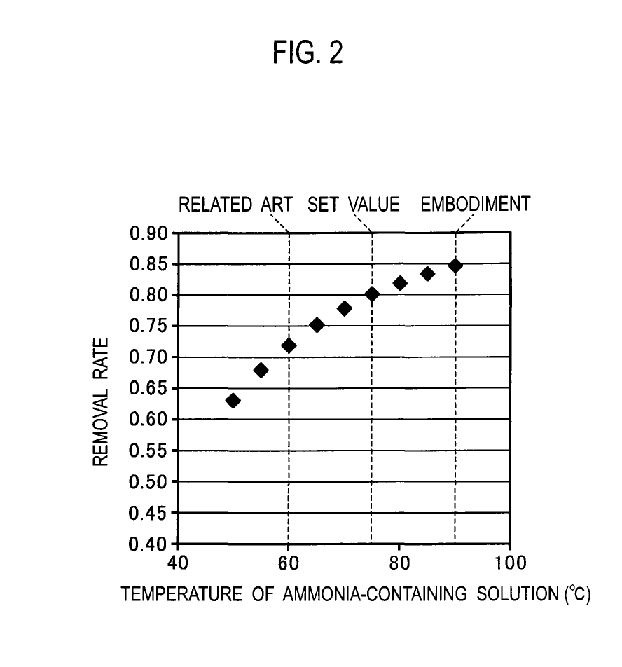

FIG. 2 is a diagram for explaining an example of a relationship between the temperature of the ammonia-containing solution Y and an ammonia removal rate in the stripping tower 230. In FIG. 2, let us assume that the figure “1.00” on the scale representing the ammonia removal rate means that the ammonia is removed by 100%. It should be noted, however, that 100% of the ammonia cannot be removed from the ammonia-containing solution according to the principle of the stripping tower. As shown in FIG. 2, in the stripping tower 230, the ammonia removal rate (vaporization efficiency) from the ammonia-containing solution Y becomes higher as the temperature of the ammonia-containing solution Y becomes higher.

The conventional technique in which the ammonia-containing solution Y is pre-heated by use of the heat of the stripped gas is capable of heating the ammonia-containing solution Y only up to approximately 60° C. As long as the conventional technique is used, the maximum removal rate remains at approximately 0.72. For this reason, a process of increasing the gas-liquid contact area, a process of increasing the pH level, and the like are needed to enhance the ammonia removal rate.

In contrast, in the embodiment, the sensible heat exchanger 222 is capable of heating the ammonia-containing solution Y to approximately 80° C. to 90° C. Thus, the ammonia removal rate can be increased to approximately 0.82 to 0.85. Accordingly, the embodiment makes it possible to enhance the ammonia removal rate by 0.1 or more, i.e. by 10% or more, compared with the conventional technique in which the ammonia-containing solution Y is pre-heated by use of the heat of the stripped gas.

Furthermore, for example, when the ammonia removal rate is set at 0.8 in the stripping tower 230, the conventional technique in which the ammonia-containing solution Y is pre-heated by use of the heat of the stripped gas essentially requires steam to be introduced into the stripping tower 230. By contrast, the stripping system 200 of the embodiment requires no steam to be introduced into the stripping tower 230, since the sensible heat exchanger 222 is capable of heating the ammonia-containing solution Y sufficiently. For this reason, when the embodiment achieves almost the same level of ammonia removal rate as does the conventional technique in which the ammonia-containing solution Y is pre-heated by use of the heat of the stripped gas, the embodiment can significantly reduce the amount of steam to be introduced into the stripping tower 230. Accordingly, the embodiment can inhibit an increase in the amount of drainage water to be discharged from the stripping tower 230, and can thereby reduce costs of processing the drainage water. It should be noted that the target value of the ammonia removal rate may be changed as needed, depending on the concentration of the ammonia in the ammonia-containing solution Y, and regulation values in a community where the drainage water is discharged.

Moreover, the sensible heat exchanger 222 heats the ammonia-containing solution Y by use of the heat of the condensed water which would be otherwise discharged. This makes it possible to save energy for heating (pre-heating) the ammonia-containing solution Y.

In addition, the configuration of the air introducer 224 to introduce the heated air into the stripping tower 230 can further raise the temperature of the ammonia-containing solution Y in the stripping tower 230, and accordingly can further enhance the vaporization efficiency of the ammonia-containing solution Y. Furthermore, when the embodiment achieves almost the same level of ammonia removal rate as does the conventional technique in which steam is introduced into the stripping tower 230 without heating the ammonia-containing solution Y, the embodiment can significantly reduce the amount of steam to be introduced into the stripping tower 230.

### Second Embodiment

The foregoing descriptions have been provided for the first embodiment in which: the synthesis gas generating system 100 includes the stripping tower 230 configured to vaporize and thus remove the ammonia from the ammonia-containing solution Y; and the ammonia-containing solution Y is heated before introduced into the stripping tower 230. The following descriptions will be provided for a second embodiment in which a synthesis gas generating system includes a stripping tower configured to vaporize and thus remove a substance other than ammonia.

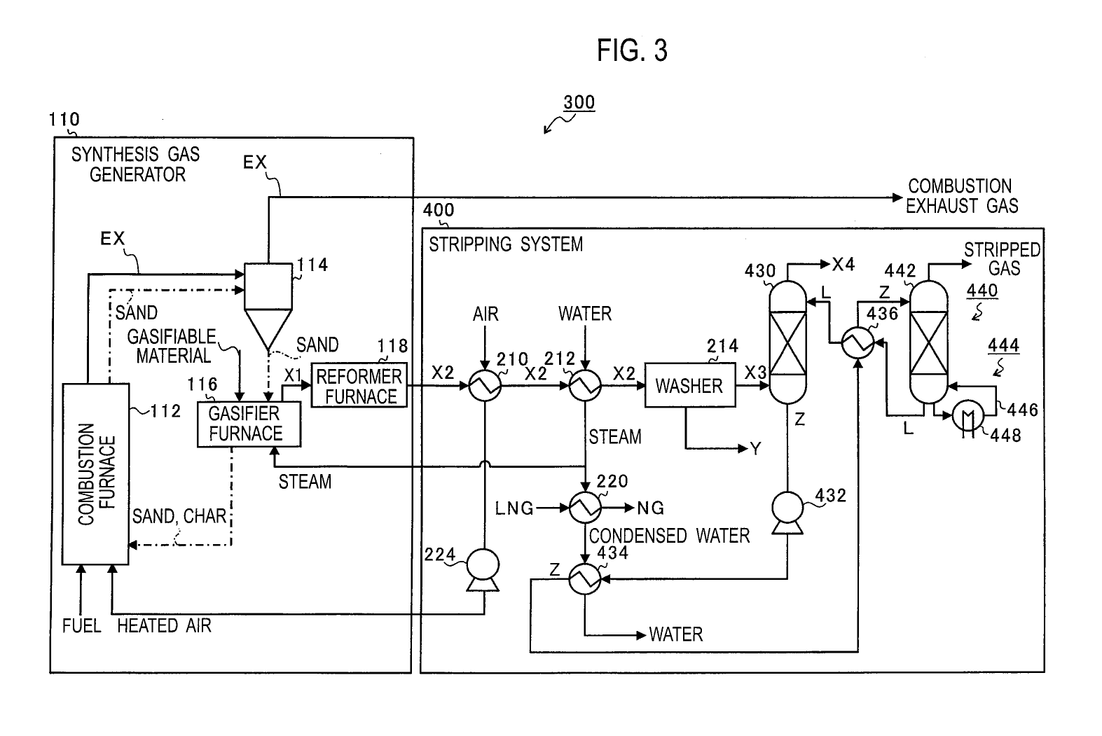

FIG. 3 is a diagram for explaining a synthesis gas generating system 300 of the second embodiment. As shown in FIG. 3, the synthesis gas generating system 300 includes a synthesis gas generator 110 and a stripping system 400. In FIG. 3, flows of sand are indicated with chain dashed lines, while flows of things other than the sand including, a gasifiable material, gases, water, oil, and the like are indicated with solid lines. In addition, the synthesis gas generator 110 has substantially the same functions as the synthesis gas generator 110 which has been discussed as one component of the first embodiment. For this reason, duplicate descriptions for the synthesis gas generator 110 will be omitted.

### Stripping System 400

As shown in FIG. 3, the stripping system 400 includes an air heater 210, a boiler 212, a washer 214, a latent heat exchanger (first heat exchanger) 220, an absorbing unit 430, an untreated water sending unit 432, a sensible heat exchanger (second heat exchanger) 434, an absorbing solution heat exchanger 436, and a recycling unit 440. It should be noted that the air heater 210, the boiler 212, the washer 214 and the latent heat exchanger 220 have substantially the same functions as those which have been discussed as components of the first embodiment, respectively. For this reason, duplicated descriptions for these components will be omitted. In the following, detailed descriptions will be provided for the absorbing unit 430, the untreated water sending unit 432, the sensible heat exchanger 434, the absorbing solution heat exchanger 436 and the recycling unit 440.

The refined gas X3 washed by the washer 214 is likely to contain an acid gas. Depending on the subsequent facility which uses the refined gas, the acid gas needs to be removed from the refined gas X3. With this taken into consideration, in this embodiment, the absorbing unit 430 removes the acid gas from the refined gas X3.

An absorbing solution (hereinafter referred to as a “lean absorbing solution L”) and the refined gas X3 containing the acid gas (carbon dioxide in this case) are introduced into the absorbing unit (absorbing tower) 430, which washes the refined gas X3 with the lean absorbing solution L. Thus, the carbon dioxide contained in the refined gas X3 is absorbed into the lean absorbing solution L, whereby a refined gas X4 from which the carbon dioxide is removed and an acid gas-containing absorbing solution (in the form of untreated water) Z are obtained.

The lean absorbing solution L is made from an aqueous solution which contains a chemical compound with affinity to carbon dioxide, like alkanolamine or its similarity, as an absorbent.

The untreated water sending unit 432 is formed from a pump, for example, and sends the acid gas-containing absorbing solution Z, generated by the absorbing unit 430, to a stripping tower 442 via the sensible heat exchanger 434 and the absorbing solution heat exchanger 436 which will be described later.

The sensible heat exchanger 434 collects the sensible heat of the condensed water condensed by the sensible head exchanger 220, and heats the acid gas-containing absorbing solution Z, which has been discharged from the absorbing unit 430, by use of the collected heat. To put it specifically, the sensible heat exchanger 434 exchanges heat between the condensed water and the acid gas-containing absorbing solution Z, as well as thereby cools the condensed water and heats the acid gas-containing absorbing solution Z. The sensible heat exchanger 434 heats the acid gas-containing absorbing solution Z to approximately 80° C. to 90°, for example.

The absorbing solution heat exchanger 436 exchanges heat between the acid gas-containing absorbing solution Z heated by the sensible heat exchanger 434 and the lean absorbing solution L discharged from the stripping tower 442 which will be described later, as well as thereby cools the lean absorbing solution L and further heats the acid gas-containing absorbing solution Z.

The recycling unit 440 recycles the acid gas-containing absorbing solution Z into the lean absorbing solution L by: heating the acid gas-containing absorbing solution Z sent from the absorbing unit 430; and vaporizing the carbon dioxide from the acid gas-containing absorbing solution Z. To put it specifically, the recycling unit 440 includes the stripping tower 442 and a re-boiler 444.

The acid gas-containing absorbing solution Z heated by the sensible heat exchanger 434 and the absorbing solution heat exchanger 436 is introduced into the stripping tower 442. The re-boiler 444 further heats the acid gas-containing absorbing solution Z and thus vaporizes the carbon dioxide from the acid gas-containing absorbing solution Z, thereby generating a stripped gas (a gaseous mixture of the carbon dioxide and steam) and the lean absorbing solution L.

The re-boiler 444 is formed from a circulation line 446 and a heater 448, and recirculates the acid gas-containing absorbing solution Z in the stripping tower 442. To put it specifically, the circulation line 446 circulates the acid gas-containing absorbing solution Z by: once sending the acid gas-containing absorbing solution Z from the stripping tower 442 to the outside of the stripping tower 442; and introducing the acid gas-containing absorbing solution Z into the stripping tower 442 again. The heater 448 is formed from a steam heater, an electric heater or the like, and heats the acid gas-containing absorbing solution Z flowing in the circulation line 446.

Descriptions will be provided for how the absorbing solution flows. The acid gas-containing absorbing solution Z generated by the absorbing unit 430 is heated by the sensible heat exchanger 434 and the absorbing solution heat exchanger 436, and is subsequently sent to the stripping tower 442. Thereafter, the acid gas-containing absorbing solution Z introduced into the stripping tower 442 is further heated by the re-boiler 444. The further heating of the acid gas-containing absorbing solution Z by the re-boiler 444 vaporizes and thus removes the carbon dioxide from the acid gas-containing absorbing solution Z. The lean absorbing solution L thus recycled by the removal of the carbon dioxide in the stripping tower 442 is cooled by the absorbing solution heat exchanger 436, and is returned to the absorbing unit 430. As described above, the absorbing solution is circulated between the absorbing unit 430 and the stripping tower 442.

In this respect, descriptions will be provided for how the stripping tower 442 vaporizes the carbon dioxide from the acid gas-containing absorbing solution Z. In the stripping tower 442, the removal rate (vaporization efficiency) of the carbon dioxide from the acid gas-containing absorbing solution Z becomes higher as the temperature of the acid gas-containing absorbing solution Z becomes higher.

With this taken into consideration, the embodiment introduces the acid gas-containing absorbing solution Z into the stripping tower 442 after heating the acid gas-containing absorbing solution Z by use of the sensible heat exchanger 434. This can improve the removal rate of the carbon dioxide compared to a configuration in which the acid gas-containing absorbing solution Z is introduced into the stripping tower 442 without being heated, and a configuration in which the acid gas-containing absorbing solution Z is heated only by the absorbing solution heat exchanger 436, on the assumption that the heating performance of the re-boiler 444 is almost the same.

Furthermore, since the sensible heat exchanger 434 is capable of heating the acid gas-containing absorbing solution Z sufficiently, the embodiment can significantly reduce the amount of heating by the re-boiler 444 when the removal rate is almost the same between the embodiment and the configuration in which the acid gas-containing absorbing solution Z is introduced into the stripping tower 442 without being heated, or the configuration in which the acid gas-containing absorbing solution Z is heated only by the absorbing solution heat exchanger 436.

Moreover, since the sensible heat exchanger 434 heats the acid gas-containing absorbing solution Z by use of the heat of the condensed water which would be otherwise discharged, the embodiment can save the amount of energy for heating the acid gas-containing absorbing solution Z (required by the re-boiler 444).

Although the foregoing descriptions have been provided for the preferable embodiments of the present invention while referring to the attached drawings, it is needless to say that the present invention is not limited to these embodiments. It is obvious to those skilled in the art that various alterations and modifications can be arrived at within the scope of the claims. It shall be understood that such alterations and modifications are naturally encompassed by the present invention as well.

For example, since the heat source for the boiler 212 is the synthesis gas X2 generated by the gasifier furnace 116, the embodiments can generate the steam while cooling the synthesis gas X2. However, what is required of the boiler 212 is at least to be capable of generating the steam. No specific restriction is imposed on the heat source of the boiler 212.

What is more, in the foregoing first embodiment, tar and sludge are likely to be contained in the ammonia-containing solution Y obtained by the washer 214. In this case, a removal mechanism configured to remove the tar and sludge from the ammonia-containing solution Y may be provided between the washer 214 and the sensible heat exchanger 222.

In addition, the foregoing descriptions have been provided for the embodiments in which the latent heat exchanger 220 is configured to heat the LNG by use of the latent heat of the steam generated by the boiler 212. The latent heat exchanger 220, however, may heat any other substance as long as the latent heat exchanger 220 is capable of collecting the latent heat of the steam generated by the boiler 212 and thereby condensing the steam. For example, the latent heat exchanger 220 may be used as a re-boiler or as a heat source for drying brown coal (coal with relatively high percentage of water content).

Furthermore, the foregoing second embodiment has been described while citing the carbon dioxide as an example of the acid gas. Instead, however, the acid gas may be hydrogen sulfide or the like. If the acid gas is hydrogen sulfide, it is needless to say that the absorbing solution needs to be made of an aqueous solution which contains a chemical compound with affinity to hydrogen sulfide as the adsorbent.

What is more, the synthesis gas generating system 300 may include the stripping tower 230.

What is claimed is:

1. A stripping system comprising:
a boiler configured to generate steam by heating water;
a first heat exchanger configured to collect latent heat of the steam generated by the boiler, and thereby to condense the steam into condensed water;
a second heat exchanger configured to collect sensible heat of the condensed water, and thereby to heat any of untreated water absorbing ammonia and untreated water absorbing an acid gas by use of the collected heat; and
a stripping tower into which the heated untreated water is introduced, the stripping tower configured to vaporize any of the ammonia and the acid gas from the untreated water.

2. The stripping system according to claim 1, further comprising an air introducer configured to introduce heated air into the stripping tower.

3. The stripping system according to claim 1, wherein a heat source for the boiler is a synthesis gas generated by heating a gasifiable material.

4. The stripping system according to claim 3, further comprising a washer configured to wash the synthesis gas with water, thereby to cause the water to absorb ammonia contained in the synthesis gas, and thus to obtain the untreated water containing the ammonia, wherein
the second heat exchanger collects the sensible heat of the condensed water, and heats the untreated water obtained by the washer by use of the collected heat, and
the stripping tower receives the heated untreated water introduced therein, and vaporizes the ammonia from the untreated water.

5. The stripping system according to claim 3, further comprising an absorbing unit configured to wash the synthesis gas with an absorbing solution, thereby to cause the absorbing solution to absorb the acid gas contained in the synthesis gas, and thus to obtain the untreated water containing the acid gas, wherein
the second heat exchanger collects the sensible heat of the condensed water, and heats the untreated water obtained by the absorbing unit by use of the collected heat, and
the stripping tower receives the heated untreated water introduced therein, and vaporizes the acid gas from the untreated water.

6. The stripping system according to claim 2, wherein a heat source for the boiler is a synthesis gas generated by heating a gasifiable material.

7. The stripping system according to claim 6, further comprising a washer configured to wash the synthesis gas with water, thereby to cause the water to absorb ammonia contained in the synthesis gas, and thus to obtain the untreated water containing the ammonia, wherein
the second heat exchanger collects the sensible heat of the condensed water, and heats the untreated water obtained by the washer by use of the collected heat, and
the stripping tower receives the heated untreated water introduced therein, and vaporizes the ammonia from the untreated water.

8. The stripping system according to claim 6, further comprising an absorbing unit configured to wash the synthesis gas with an absorbing solution, thereby to cause the absorbing solution to absorb the acid gas contained in the synthesis gas, and thus to obtain the untreated water containing the acid gas, wherein
the second heat exchanger collects the sensible heat of the condensed water, and heats the untreated water obtained by the absorbing unit by use of the collected heat, and
the stripping tower receives the heated untreated water introduced therein, and vaporizes the acid gas from the untreated water.
